(19) United States
(12) Patent Application Publication
(10) Pub. No.: US 2006/0074538 A1
(43) Pub. Date: Apr. 6, 2006

(54) Emergency stop system for a non rail-based motor vehicle

(75) Inventors: Wolf-Dietrich Bauer, Leinfelden-Echterdingen (DE); Jochen Horwath, Unterensingen (DE); Andreas Schwarzhaupt, Landau (DE); Gernot Spiegelberg, Heimsheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuggart (DE)

(21) Appl. No.: 10/518,363

(22) PCT Filed: May 3, 2003
(86) PCT No.: PCT/EP03/04652

§ 371 Date: Jun. 25, 2005

(30) Foreign Application Priority Data
Jun. 19, 2002 (DE) 10227295.6

(51) Int. Cl. G06F 19/00

(52) U.S. Cl. 701/48; 701/41; 701/70

(57) ABSTRACT

A steering system with a steering adjustment unit, based on the “steer by wire” concept, with an additional system for an automatic emergency stopping maneuver is provided. In situations that cannot be controlled by the driver, preset data from a preset or storage arrangement are transmitted to a braking system and a steering adjustment unit, with the vehicle then being braked and steered according to the preset data.

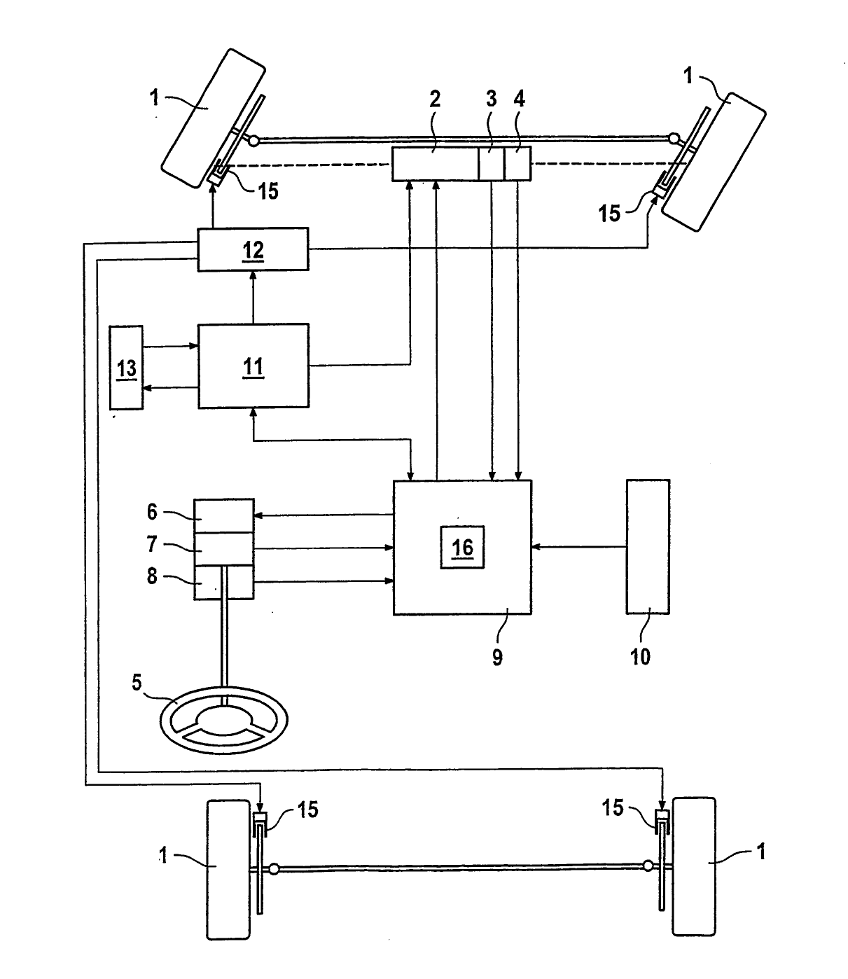

### BACKGROUND AND SUMMARY OF THE INVENTION

The present invention relates to a steering system for a non-railborne motor vehicle with a motor-driven steering adjustment unit which controls the steerable wheels of a vehicle, and which is actuated by a steering control arrangement on the basis of a comparison between signals indicating the actual steering angle value generated by an actual value transmitter actuated by the steerable wheels of the vehicle and signals indicating the nominal steering angle value generated by a nominal preset value unit.

In conventional motor vehicles, the manual steering mechanism, usually a steering wheel, is forcibly linked to the steerable wheels of the vehicle so that the steering wheel and the steerable wheels of the vehicle always perform analogous adjustment movements. Servo units also ensure that the manual forces which need to be exerted on the steering wheel remain small.

Steering systems are now, however, being developed in which the manual steering mechanism and the steerable wheels of the vehicle are linked only functionally via a control system. The steerable wheels of the vehicle or parts linked to them actuate an actual steering angle transmitter. The steering mechanism acts upon a nominal steering angle transmitter. A controller compares the nominal value signals from the nominal value transmitter with the actual value signals from the actual value transmitter and actuates a motor-driven adjustment unit linked with the steerable wheels of the vehicle to adjust their steering angle on the basis of the comparison. In this concept, also known as “steer-by-wire”, the basic advantage is that, in addition to the control of the manual steering mechanism by the driver, many other parameters can be taken into account when the adjustment unit is actuated. Moreover, there is no need for a steering column, which essentially presents a danger during vehicle collisions.

This kind of steering system is particularly well suited to automatic steering interventions, for example, to minimize the effects of a cross wind or the like on the desired path of the vehicle.

German Patent Document DE 198 41 914 A1 discloses an automatic steering system which, while the vehicle is traveling in one direction (e.g., forward), can register essential data for the route covered and the steering maneuvers performed such that the vehicle can subsequently travel in a reverse direction (e.g., backward) automatically in the path covered before when traveling in the first direction.

The present invention provides increased safety in driving situations that can no longer be driver-controlled with a steering system of the type described above.

This is achieved by equipping the vehicle with a system for automatic braking intervention, a system for recognizing driving conditions beyond the control of the driver and a default or storage arrangement with preset data for an emergency stopping maneuver, and by causing the steering adjustment unit as well as the system for automatic braking interventions to automatically follow the preset emergency data in one of the driving conditions beyond the control of the driver.

The present invention makes an automatic emergency vehicle stopping maneuver possible by constantly collecting steering data suitable for such a maneuver and keeping it ready to control a system existing in the vehicle for automatic braking intervention and the motor-driven steering adjustment unit in a manner suitable for emergencies.

System components already existing in the vehicle and basically well-known can be advantageously used to implement the present invention.

Thus, for example, systems for automatic braking intervention are basically well-known and are already standard in many vehicles in order, for example, to assist steering maneuvers initiated by the driver by selective braking intervention on individual wheels or to reduce the danger of the vehicle spinning out when cornering at speed. Such systems are basically suitable, when appropriately controlled, for bringing a vehicle automatically to a stop in an emergency stopping maneuver.

The same applies to the motor-driven steering adjustment unit necessary in steering systems of the type described above which, according to the present invention, like the system for automatic braking interventions, only has to follow the commands for the emergency stopping path during the emergency stopping maneuver.

In addition to the steering and braking systems, other systems can also come under automatic control when emergency maneuvers are performed, e.g., there can be intervention in the spring/shock absorber systems of a chassis, in engine control systems and/or a vehicle's drive transmission control systems or the like.

The result is that the vehicle can therefore be accelerated or decelerated in an emergency maneuver by appropriate preset data in a longitudinal, transverse and/or up-and-down direction.

The present invention is suitable for multiple emergency situations, including emergencies caused both by the driver and by the vehicle.

In the event that extreme faintness on the part of the driver is registered by an appropriate sensor system, a vehicle according to the invention can stop automatically. If, on the other hand, there is the highly unlikely occurrence of a break in the signal path between the steering adjustment unit and the controller, the storage arrangement is still available with preset data for the emergency stopping maneuver. This storage arrangement is, according to a preferred embodiment of the present invention, arranged in parallel to the signal path between the controller and the steering adjustment unit and separate from the controller.

According to one embodiment of the present invention, the preset data for the emergency stopping maneuver are constantly updated by means of an appropriate sensor system so that when an emergency actually occurs an optimal stopping maneuver is performed automatically.

In this connection, the sensor system mentioned above can, for example, constantly evaluate the data from a navigation system (GPS) in order to store the street layout for a driving stretch that is sufficient for a stopping maneuver. There can also be means provided for recognizing other vehicles and obstacles, so that in an emergency stopping maneuver the last state of the vehicle's surroundings can always be taken into account before the emergency occurs, and in the case of moving obstacles, i.e., particularly for other vehicles registered by the system, their last determined direction and speed are recorded as needed so that the last determined situation can be extrapolated to a future period of time.

Reference is made hereinafter, with respect to preferred features of the invention, to the claims and the following explanation of the diagram which is used to describe in detail an especially preferred form of the invention.

### BRIEF DESCRIPTION OF THE DRAWING

The single FIGURE shows a block diagram of the steering system of the invention.

### DETAILED DESCRIPTION

A vehicle, not shown in detail, possesses front and rear wheels 1, with the steerable front wheels being linked by motor-driven steering adjustment unit 2 for their steering adjustment. An actual value transmitter 3, whose signals give the actual value of the particular steering angle, and a pressure and force measuring device 4, whose signals reflect the steering forces developed between steerable front wheels 1 and steering adjustment unit 2, are assigned to front wheels 1 and steering adjustment unit 2.

Steering wheel 5, operated by the driver, is linked to manual force adjuster 6, which serves to change the hand forces applied on the steering wheel. The torques developed between manual force adjuster 6 and the steering wheel are recorded by means of torque meter 7. Steering wheel 5 also acts together with angle measuring unit 8 whose signals reflect the steering angle desired by the driver.

The inputs to control device 9 come from actual value transmitter 3, pressure and force measuring device 4, torque meter 7 and angle measuring unit 8. Steering adjustment unit 2 and manual force adjuster 6 are connected to the output side. Control device 9 can also have an input connection from another sensor system 10 which allows recording of the driving condition parameters of the vehicle, such as, for example, yawing movements and lateral accelerations of the vehicle, as well as crosswind effects.

In normal driving situations, the signal from angle measuring unit 8, which reflects the steering angle preset by the driver on steering wheel 5, is processed as the nominal baseline steering angle value. If sensor system 10 is present, its signals can be used to modify the nominal baseline value to take the particular special driving situation or the particular recorded driving condition parameters into account in the nominal steering angle value. This nominal steering angle value is compared with the actual steering actual value recorded by actual value transmitter 3. Based on the nominal value-actual value comparison, control device 9 actuates steering adjustment unit 2. As a result the actual steering angle value therefore follows the nominal steering angle value.

The steering forces produced between steering adjustment unit 2 and steerable front wheels 1 and recorded by pressure and force measuring device 4, or the signals representing these forces, are processed by control device 9 as the nominal preset value for actuating manual force adjuster 6 so that control device 9 is able, by corresponding actuation of manual force adjuster 6, to produce a force appropriate to the particular driving situation which opposes the turning action of steering wheel 5. The actual forces produced between manual force adjuster 6 and steering wheel 5 in each case are recorded by torque meter 7 and “reported” to control device 9.

Basically, control device 9 can, if necessary, also simulate, by means of manual force adjuster 6, sudden twists or other effects occurring with the conventional steering systems.

According to the present invention, the vehicle also possesses preset or storage arrangement 11 which allows an automated vehicle stopping maneuver without driver involvement to be carried out in extreme danger situations.

This preset or storage arrangement 11 has parallel output connections to control device 9 and steering adjustment unit 2. A system 12 for an automatic braking intervention, which can control wheel brake units 15 for each wheel or each axle in order to slow or stabilize the vehicle, is also connected to the output side of preset or storage arrangement 11. When steering adjustment unit 2 and system 12 are correspondingly actuated for automatic braking intervention, preset or storage arrangement 11 can therefore perform a vehicle stopping maneuver.

On the input side, preset or storage arrangement 11 is connected with theoretically any system, but especially sensor systems whose signals are suitable or useful for ascertaining an optimal stopping path.

Accordingly, preset or storage arrangement 11 can constantly communicate with control device 9 so as to be able to take into account all data present there, and especially the signals of the sensors working with control device 9. Additionally or alternatively, preset or storage arrangement 11 can also communicate directly with the aforementioned sensors.

Furthermore, preset or storage arrangement 11 can be connected to sensor devices 13 to record the particular driving path. An example of such a device is a navigation system which can represent both the geographic position of the vehicle and the course driven by the vehicle in the form of corresponding signals. Another example is a detection system for vehicles driving ahead or obstacles in the driving direction.

Another system 16 is preferably provided for recognition of driving conditions beyond the control of the driver. This system 16 can therefore recognize with sensors (not shown here) whether the driver has lost control of the vehicle due to technical problems or outside circumstances such as, for example, loss of driver consciousness. In the example shown, system 16 is integrated into steering control arrangement 9 and monitors the communication between steering control arrangement 9 and the steering adjustment unit. The system can also be connected to a sensor system for monitoring the driver, such as, for example, a drowsiness warning device.

All data from systems 9, 13 and 16 communicating with the preset or storage arrangement are processed as control data for an optimal emergency stopping maneuver and stored, with these data being constantly updated. As a rule, control data are therefore stored at different points in time for emergency stopping maneuvers that vary from one another. The data of no longer current emergency stopping maneuvers are constantly erased or removed from the corresponding data storage.

In normal driving situations, preset or storage arrangement 11 is not active.

Only if an extremely dangerous condition occurs, for example if a break in the signal path between control device 9 and steering adjustment unit 2 is detected, do the control data present in preset or storage arrangement 11 become active for an emergency stopping maneuver; they are then sent to steering adjustment unit 2 and to system 12 for automatic braking intervention. The vehicle therefore performs a steering and braking maneuver until the vehicle comes to a stop.

1-7. (canceled)

8. A steering system for a non-railborne motor vehicle which a motor-driving steering adjustment unit which controls steerable vehicle wheels and is actuated by a steering control arrangement on the basis of a comparison between actual steering angle signals from an actual value transmittal actuated with the steerable vehicle wheels and nominal steering angle signals from a nominal value preset unit,
wherein the vehicle includes a system for automatic braking intervention, a system for recognizing driving conditions beyond a driver's control and preset or storage arrangement with preset data for an emergency stopping maneuver, and
wherein the steering adjustment unit and the system for automatic braking interventions follow the preset data.

9. The steering system according to claim 8, wherein the preset data are constantly updated by sensors which sense operating and path conditions.

10. The steering system according to claim 9, wherein the sensors can detect obstacles and/or other vehicles.

11. The steering system according to claim 9, wherein the sensor systems includes a navigation system which provides data on a particular section of the path ahead.

12. The steering system according to claim 8, wherein the system for recognizing driving conditions beyond the driver's control can detect loss of consciousness of a driver.

13. The steering system according to claim 8, wherein the preset or storage arrangement becomes active when there is a break in a signal path between the steering adjustment unit and the steering control arrangement.

14. The steering system according to claim 8, wherein the preset or storage arrangement contains only command data for an emergency stopping path.

15. A motor vehicle, comprising:
a motor-driven steering adjustment unit, which controls steerable vehicle wheels;
a steering control arrangement, which actuates the motor-driven steering adjustment unit on the basis of a comparison between actual steering angle signals from an actual valve transmitter actuated with the steerable vehicle wheels and nominal steering angle signals from a nominal value preset unit;
a system for automatic braking intervention;
a system for recognizing driving conditions beyond a driver's control; and
a storage arrangement, which stores preset data for an emergency stopping maneuver.
wherein the steering adjustment unit and the system for automatic braking interventions follow the preset data.

16. The steering system according to claim 15, wherein the preset data are constantly updated by sensors which sense operating and path conditions.

17. The steering system according to claim 16, wherein the sensors can detect obstacles and/or other vehicles.

18. The steering system according to claim 16, wherein the sensor systems includes a navigation system which provides data on a particular section of the path ahead.

19. The steering system according to claim 15, wherein the system for recognizing driving conditions beyond the driver's control can detect loss of consciousness of a driver.

20. The steering system according to claim 15, wherein the preset or storage arrangement becomes active when there is a break in a signal path between the steering adjustment unit and the steering control arrangement.

21. The steering system according to claim 15, wherein the preset or storage arrangement contains only command data for an emergency stopping path.
